(19) United States
(12) Patent Application Publication
(10) Pub. No.: US 2014/0079523 A1
(43) Pub. Date: Mar. 20, 2014

(54) JOINT INTERFACE FOR LAMINATE STRUCTURES

(71) Applicants: Jeff A. Jensen, Dunlap, IL (US); Kevin Martin, Washburn, IL (US); Benjamin Nelson, Peoria, IL (US); Aaron Amstutz, Peoria, IL (US)

(72) Inventors: Jeff A. Jensen, Dunlap, IL (US); Kevin Martin, Washburn, IL (US); Benjamin Nelson, Peoria, IL (US); Aaron Amstutz, Peoria, IL (US)

(73) Assignee: Caterpillar Inc., Peoria, IL (US)

(21) Appl. No.: 13/617,480

(22) Filed: Sep. 14, 2012

(51) Int. Cl. B32B 3/00; E02F 3/40; E02F 3/38; E02F 3/28

(52) U.S. Cl. 414/727; 428/53

(57) ABSTRACT

A laminate structure is provided. The laminate structure includes a plurality of laminate layers. The laminate structure also includes a joint interface. The joint interface includes a retention member at least partially disposed between any two of the plurality of laminate layers. Further, the retention member has an opening for receiving a pin retaining member. The retention member is configured to provide a surface for transitioning the pin retaining member to the laminate structure.

### TECHNICAL FIELD

The present disclosure relates to laminate structures and more particularly to the laminate structure used in a linkage member for a machine.

### BACKGROUND

Pin joints in a linkage member may be used to connect the linkage member to different components of a machine. For example, U.S. Pat. No. 5,316,709 relates to manufacturing a dipper stick having a box shaped structure including an outer casing member. The outer casing member is formed of a high strength polymeric composite material. An inner filler comprising polyurethane foam is disposed inside the outer casing member in order to be integrated with the outer casing member. A plurality of bushing holders made of polymeric composite material are disposed at respective connecting portions of the box shaped structure in order to be integrated with the box shaped structure.

### SUMMARY OF THE DISCLOSURE

In one aspect of the present disclosure, a laminate structure is provided. The laminate structure includes a plurality of laminate layers. The laminate structure also includes a joint interface. The joint interface includes a retention member at least partially disposed between any two of the plurality of laminate layers. Further, the retention member has an opening for receiving a pin retaining member. The retention member is configured to provide a surface for transitioning the pin retaining member to the laminate structure.

Other features and aspects of this disclosure will be apparent from the following description and the accompanying drawings.

### BRIEF DESCRIPTION OF THE DRAWINGS

FIG. 1 is a diagrammatic view of an exemplary machine, according to one embodiment of the present disclosure;

FIG. 2 is a stick of the machine having a plane OO;

FIG. 3 is a cross-sectional view of the stick along the plane OO shown in FIG. 2;

FIG. 4 is a cross-sectional view of a joint interface having a retention member;

FIGS. 5 and 6 are diagrammatic views of various types of the retention member; and

FIGS. 7 and 8 are cross-sectional views of various types of a laminate structure including the retention member.

### DETAILED DESCRIPTION

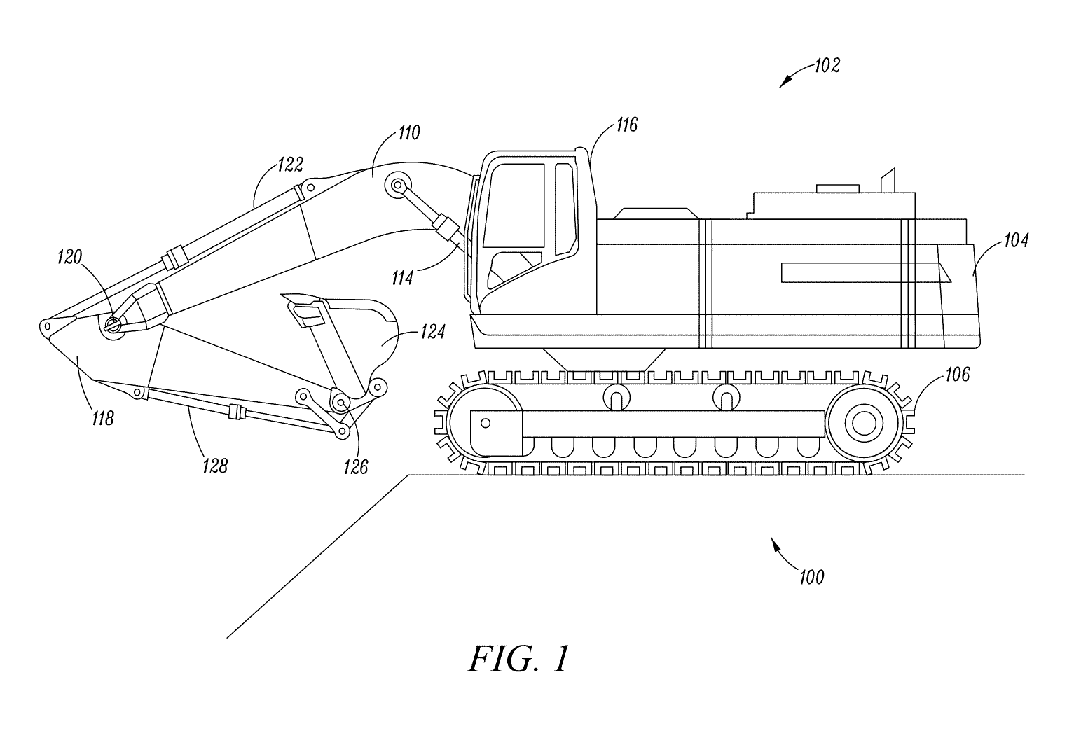

FIG. 1 illustrates an exemplary machine 100 according to one embodiment of the present disclosure. In one embodiment, the machine 100 may embody an excavator 102. It should be noted that the machine 100 may include other industrial machines such as a back hoe loader, shovel, or any other construction machines that are known in the art, and more specifically machines that make use of linkage members. As shown in FIG. 1, the machine 100 may include a body 104 that is rotatably mounted on tracks 106.

Further, the machine 100 may include a linkage member such as a boom 110 which is pivotally mounted on the body 104. The boom 110 may extend outwards. A hydraulic cylinder 114 (or a pair of cylinders), controlled by an operator sitting in an operator cab 116 or by a machine control system, may move the boom 110 relative to the body 104 during operation.

Also, a stick 118 may be pivotally mounted at a pivot point 120 to an outer end of the boom 110. Similarly, a hydraulic cylinder 122 may be used to move the stick 118 relative to the boom 110 about the pivot point 120 during excavation. Further, a bucket 124 may be pivotally mounted at a pivot point 126 to an outer end of the stick 118. A hydraulic cylinder 128 may move the bucket 124 relative to the stick 118 about the pivot 126 during the operation.

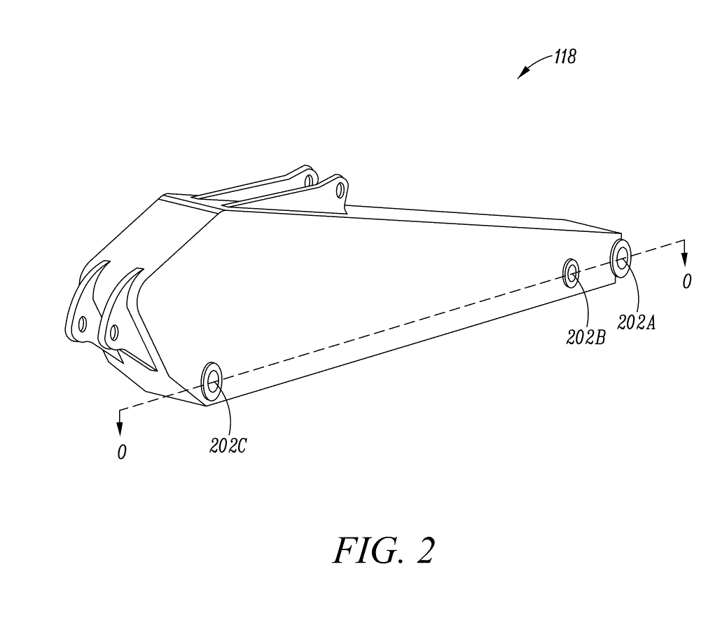

FIG. 2 illustrates an exploded view of the stick 118 having a plane OO. The stick 118 may include a number of joint interfaces 202 A-C for connecting the stick 118 to other components of the machine 100 via pin joints or bolted joints. For example, in the excavator 102, the stick 118 and the boom 110 may be connected at the joint interface 202 C, the stick 118 and the bucket 124 may be connected at the joint interface 202 A, and the like.

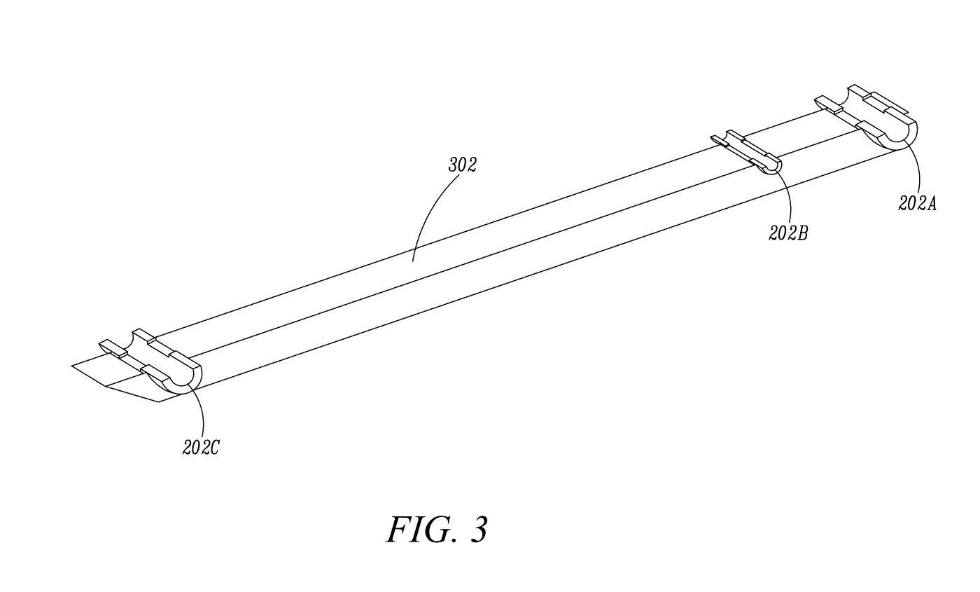

FIG. 3 illustrates a cross-sectional view of the stick 118 along the plane OO. It should be noted that at least a portion of the stick 118 may have a solid beam construction, wherein the stick 118 may be made of a laminate structure 302. More specifically, the joint interfaces 202 A-C may have such a construction. One of ordinary skill in the art will appreciate that although the joint interfaces 202 A-C described herein are associated with the stick 118, other joint interfaces present on the boom 110 and/or the bucket 124 also lie within the scope of the present disclosure.

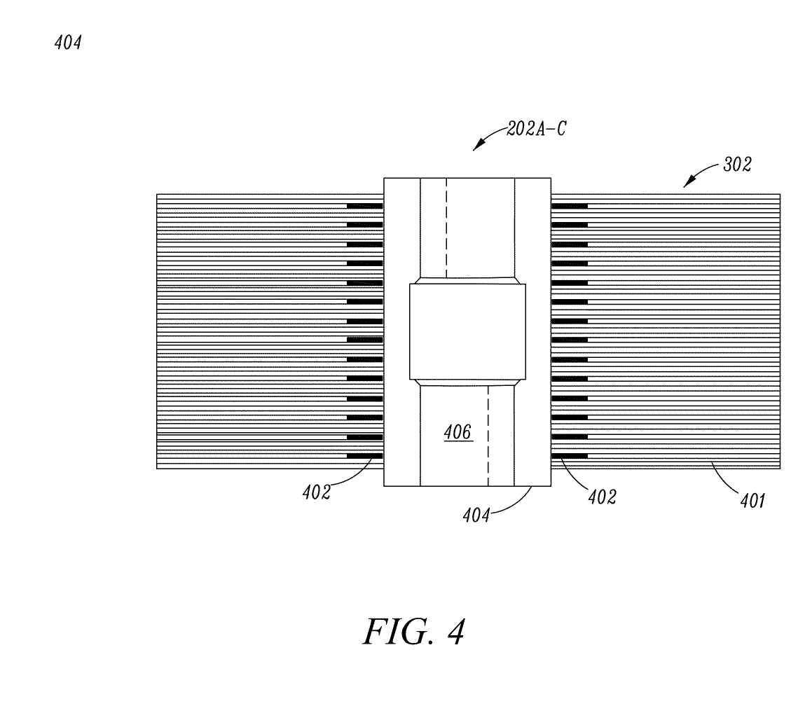

A person of ordinary skill in the art will appreciate that the laminate structure 302 may include a plurality of laminate layers 401 (see FIG. 4). In one embodiment, the plurality of laminate layers 401 may further include a layup of polymeric composites. In another embodiment, the plurality of laminate layers 401 may include self reinforced polymers based on polyethylene, polypropylene, polyester, polyamide or polyurethane. Additionally, in yet another embodiment, the plurality of laminate layers 401 may include various thermoplastic or thermoset polymers and composites.

FIG. 4 is an exploded cross-sectional view of any one of the joint interfaces 202 A-C shown in FIG. 3. The present disclosure relates to a retention member 402 positioned in between the plurality of laminate layers 401 and in proximity to the any of the joint interfaces 202 A-C. The retention member 402 is configured to provide a surface for transitioning of a pin retaining member 404 to the plurality of laminate layers 401 at the joint interface 202 A-C. The pin retaining member 404 is configured to receive a pin. As shown in the accompanied figures, the retention member 402 may be made up of a metal, like steel, or any other suitable material. The retention member 402 may resemble a flat washer like structure such that the retention member 402 is at least partially disposed between any two of the plurality of laminate layers 401.

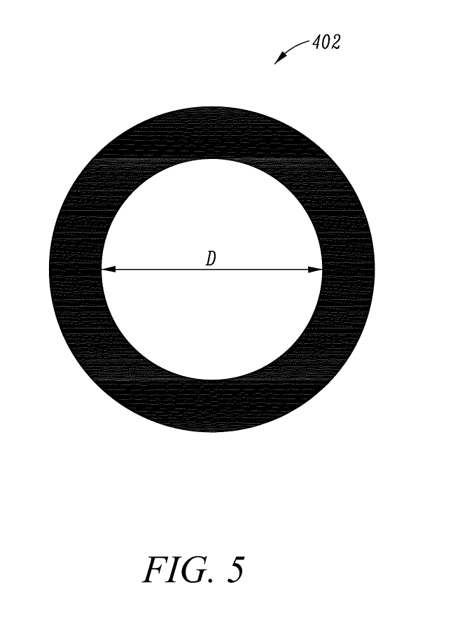

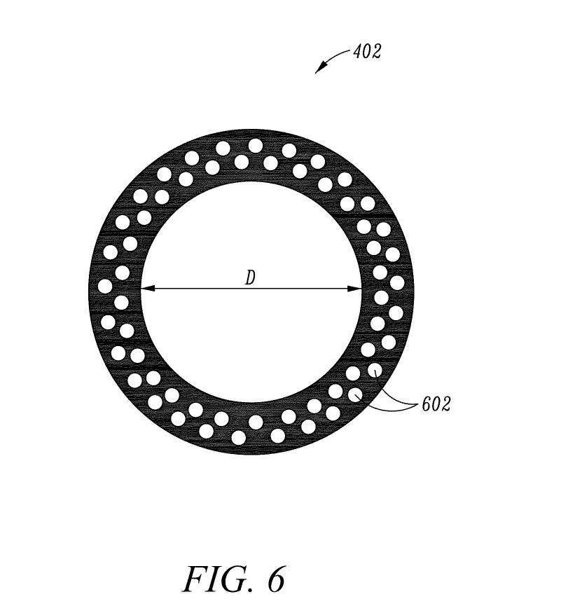

FIGS. 5 and 6 are diagrammatic views of different types of the retention member 402 according to various embodiments of the present disclosure. As shown in the accompanied figures, the retention member 402 includes a circular opening having an inner diameter D. Thickness of the retention member 402 may vary. In one embodiment, as shown in FIG. 4, a cylindrical pin retaining member 404 may be fitted in contact with the inner diameter D of the retention member 402. It should be noted that a diameter of the pin retaining member 404 may be slightly larger than the inner diameter D of the retention member 402, in order to form a press fit assembly. In one embodiment, the pin retaining member 404 may be made of steel. Moreover, the pin retaining member 404 may define a bore 406 configured to receive the pin.

Further, in another embodiment, an inner surface of the pin retaining member 404 may include threads (not shown in figures). The threads may be configured to mate with corresponding threads of a bolt. In another embodiment, a sleeve (not shown in figures) may be provided between the retention member 402 and the pin retaining member 404. The sleeve may be made of metal. It should be noted that the sleeve may be provided in order to control press-fit forces during assembly.

An outer diameter of the retention member 402 may have a variety of shapes. In one embodiment, as shown in FIGS. 5 and 6, the outer diameter of the retention member 402 may have a circular shape. Alternatively, the outer diameter of the retention member 402 may have a tear drop shape, a polygonal shape, or any other shape based on the application. In another embodiment, as shown in FIG. 6, a surface of the retention member 402 may include a plurality of perforations 602 in the form of holes, slits, slots, crosses, and the like. The plurality of perforations 602 may be configured to allow adjacent self reinforced polymer layers of the plurality of laminate layers 401 to bond with each other. This may provide mechanical locking and interface bonding of the plurality of laminate layers 401 through the retention member 402. Parameters such as the pattern of the perforations 602 on the surface, number of the perforations 602, size of the perforations 602, and the like may vary without any limitation.

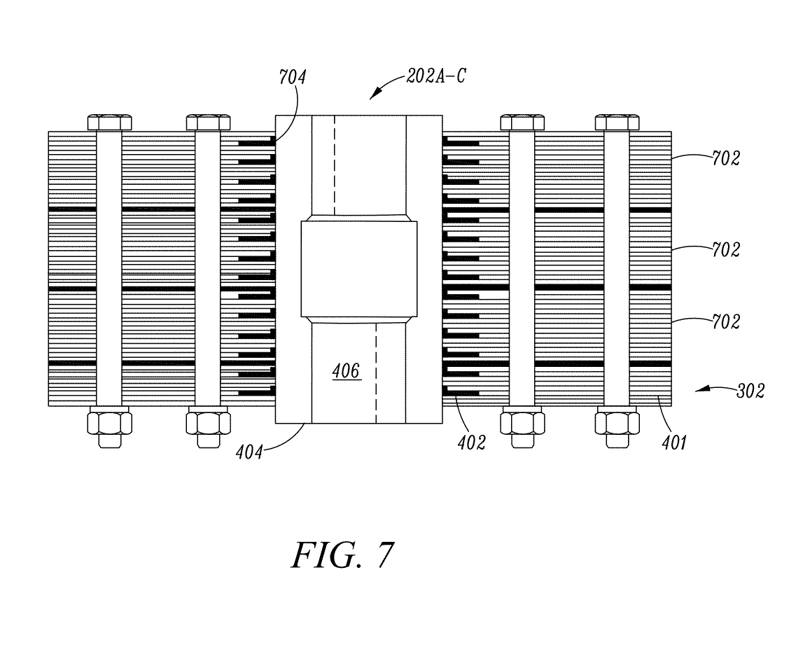

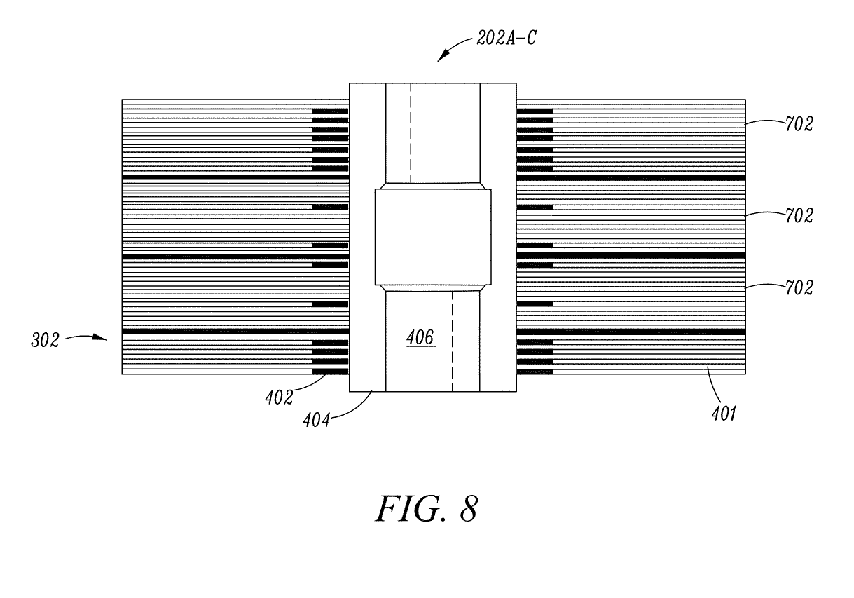

FIGS. 7 and 8 illustrate different types of the laminate structure 302. Referring to FIG. 7, one or more sections 702 of the plurality of laminate layers 401 may be bolted together. For example, a number of the sections 702 having a thickness of approximately about two inches may be combined in this manner. In one embodiment, an adhesive may be provided between the one or more sections 702. A combination of the adhesive and the bolting may provide improved resistance to inter laminar shear and layer separation in the plurality of laminate layers 401. Further, in one embodiment, a flange 704 may be provided on the inner diameter D of the retention member 402, such that the flange 704 may extend in a direction transverse to the surface of the retention member 402. Further, as shown in the accompanied figures, the flange 704 may be parallel to and in contact with the pin retaining member 404.

Referring to FIG. 8, the one or more sections 702 of the plurality of laminate layers 302 may be glued or stuck together using any suitable adhesive. Moreover, as shown in FIGS. 4, 7 and 8, a plurality of the retention members 402 may be provided in a spaced apart arrangement in between the plurality of laminate layers 302. Further, in one embodiment, the arrangement of the plurality of retention members 402 may be symmetrical about both sides of any of the joint interfaces 202 A-C. In another embodiment, the retention members 402 may be provided on either side of the any of the joint interfaces 202 A-C, such that each of the retention members 402 is provided in between alternate sections of the plurality of laminate layers 401. In one example, each of the retention members 402 may be equally spaced apart from each other (see FIGS. 4 and 7). In another example, as shown in FIG. 8, the retention members 402 may be closely spaced at outer edges of the any of the joint interfaces 202 A-C.

### INDUSTRIAL APPLICABILITY

As against using box beam or tubular structures, an alternative laminate solid type construction may be used in the manufacture of the linkage member, for example, like the stick 118, the boom 110, and/or the bucket 124 of the machine 100. The laminate structure 302 disclosed herein may be made of the self reinforced polymers. The self reinforced polymer may have a lower modulus than traditional laminates. These laminate structures 302 may be relatively thicker in order to increase a potential load bearing surface at the any of the joint interface 202 A-C. However, due to the low modulus of the laminate structure 302, the laminate structure 302 may be more susceptible to yielding of the joint. More specifically, it may be difficult to create a relatively good interface between the plurality of laminate layers 401 and the pin retaining member 404.

In the present disclosure the retention member 402 may be interleaved between the plurality of laminate layers 401. The arrangement of the plurality of the retention members 402 may provide the surface for the transitioning of the metallic pin retaining member 404 to the non-metallic plurality of laminate layers 401 at the any of the joint interfaces 202 A-C in such a way that may be favorable from a stress and loading standpoint.

An exemplary method of manufacturing the laminate structure 302 having the retention member 402 will now be described. Initially, at least one section 702 of the laminate structure 302 including the plurality of laminate layers 401 may be placed on either side of a locating fixture. The locating fixture may typically have a cylindrical shape. Thereafter, the retention member 402 may be placed between the any two of the plurality of laminate layers 401. More specifically, the retention member 402 may be placed proximal to the any of the joint interfaces 202 A-C. The above procedure may be repeated until a stack or layup of the plurality of laminate layers 401 of a desired thickness is formed. It should be noted that each of the sections 702 may include consolidated sections of the plurality of laminate layers 401 made up of the polymer or composite materials.

Further, the layup of the plurality of laminate layers 401 and the plurality of retention members 402 may be consolidated at a pre-determined temperature. It should be noted that standard autoclaving processes, hydroclaving processes, press-consolidation or combination of any other similar such methods known in the art may be used for final consolidation of the structure. In one embodiment, the locating fixture may be removed and the pin retaining member 404 may be press fit into the laminate structure 302 after the final consolidation.

A person of ordinary skill in the art will appreciate that the method of manufacturing the laminate structure 302 described above is merely on an exemplary basis and does not limit the scope of this disclosure. Also, the stick 118 and the machine 100 described herein is exemplary. The present disclosure may also be utilized on numerous other components that require bolted joints or pinned interfaces. Additionally, the disclosure may be used in a variety of applications, especially if there is a need to provide the metallic pin joint in order to handle high loads in the application.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A laminate structure comprising:
a plurality of laminate layers; and
a joint interface comprising a retention member at least partially disposed between any two of the plurality of laminate layers, the retention member having an opening for receiving a pin retaining member, wherein the retention member is configured to provide a surface for transitioning the pin retaining member to the laminate structure.

2. The laminate structure of claim 1, wherein the retention member further includes a plurality of perforations, the plurality of perforations configured to provide mechanical locking between the any two of the plurality of laminate layers.

3. The laminate structure of claim 1, wherein the opening of the retention member has a circular configuration.

4. The laminate structure of claim 1 further including a flange provided at the opening of the retention member.

5. The laminate structure of claim 1 further including a metallic sleeve fitted in contact between the retention member and the pin retaining member.

6. The laminate structure of claim 1 further including threads provided on an inner surface of the pin retaining member, the threads configured to mate with corresponding threads provided on a bolt.

7. The laminate structure of claim 1, wherein a plurality of the retention members is provided in a spaced apart arrangement within the laminate structure.

8. The laminate structure of claim 7, wherein the plurality of retention members are closely spaced at outer edges of the joint interface.

9. The laminate structure of claim 1, wherein the retention member is made of metal.

10. The laminate structure of claim 1 wherein the plurality of laminate layers comprise self reinforced polymer.

11. A linkage member for a machine, the linkage member comprising:
a laminate structure present in at least a portion of the linkage member, the laminate structure including:
a plurality of laminate layers; and
a joint interface comprising a retention member at least partially disposed between any two of the plurality of laminate layers, the retention member having an opening for receiving a pin retaining member, wherein the retention member is configured to provide a surface for transitioning the pin retaining member to the laminate structure.

12. The linkage member of claim 11, wherein the retention member further includes a plurality of perforations, the plurality of perforations configured to provide mechanical locking between the any two of the plurality of laminate layers.

13. The linkage member of claim 11, wherein the opening of the retention member has a circular configuration.

14. The linkage member of claim 11 further including a flange provided at the opening of the retention member.

15. The linkage member of claim 11 further including a metallic sleeve fitted in contact between the retention member and the pin retaining member.

16. The linkage member of claim 11 further including threads provided on an inner surface of the pin retaining member, the threads configured to mate with corresponding threads provided on a bolt.

17. The linkage member of claim 11, wherein a plurality of the retention members is provided in a spaced apart arrangement within the laminate structure.

18. The linkage member of claim 17, wherein the plurality of retention members are closely spaced at outer edges of the joint interface.

19. A machine comprising:
a power source;
a linkage member for the machine, the linkage member including at least one of a stick, a boom, and a bucket; and
wherein the at least one of the stick, the boom, and the bucket is constructed from a laminate structure, the laminate structure including:
a plurality of laminate layers; and
a joint interface comprising a retention member at least partially disposed between any two of the plurality of laminate layers, the retention member having an opening for receiving a pin retaining member, wherein the retention member is configured to provide a surface for transitioning the pin retaining member to the laminate structure.

20. The machine of claim 19, wherein the machine includes any one of an excavator, a backhoe loader, a wheel loader, and a track loader.
